(19) United States
(12) Patent Application Publication
(10) Pub. No.: US 2012/0227578 A1
(43) Pub. Date: Sep. 13, 2012

(54) Bullet proof

(76) Inventors: Stefan Klapyk, Seymour, CT (US); Miroslaw Klapyk, Seymour, CT (US)

(21) Appl. No.: 12/932,983

(22) Filed: Mar. 11, 2011

(51) Int. Cl. F41H 5/04; B23P 17/00

(52) U.S. Cl. 89/36.02; 29/592; 89/910

(57) ABSTRACT

Bullet proof, or bullet resistant, materials have been produced and improved since at least the Middle Ages. Initially these were simply the armor that fighters wore in order to protect themselves during battles. Today the goal is to manufacture a material that would protect both people and property from high speed projectiles. The bullet resistant material that we wish to present will be made out of a strain hardened carbon steel. Strain hardening will provide for a stronger material. In addition, carburization will supply extra strength. A special technique of production needed to manufacture our bullet resistant material will also be presented in this document. The product proposed by us can easily be used as armor for tanks, planes, helicopters, ships, and any protective walls, such as in bunkers. It can also be used as a material for bullet resistant vests.

### BACKGROUND

### Description of Prior Art

Bullet proof, or bullet resistant, materials have been produced and improved since at least the Middle Ages. Initially these were simply the armor that fighters wore in order to protect themselves from swords and arrows. Today, the goal is to manufacture such a material that would provide protection against a bullet or any similar high speed projectile. The goal in designing bullet resistant materials is to make these as efficient as possible, and at the same time reasonably comfortable.

### SUMMARY

Bullet resistant materials ought to be more effective, more accessible, and less expensive. These materials need to take the advantage of well know physical and chemical properties, in order for them to provide maximum possible level of protection. Even today many bullet proof materials tend to be not only expensive, but also not safe enough.

A successful bullet proof material will be a strong material, capable of stopping a fast moving projectile. Clearly, the more strength a material has, the more energy it will take to destroy it. The product that we wish to present will be made out of a strain hardened carbon steel. Strain hardening will provide for a stronger material, and carburization will supply additional strength.

### OBJECTS AND ADVANTAGES

The goal of our invention is to provide a design of a bullet resistant material that is inexpensive, easy to manufacture, and very effective. Steel is easily accessible, and methods for manufacturing it are well known. In order to strengthen steel the process of strain hardening (through plastic deformation) needs to be employed. After the steel is strain hardened, it needs to be carburized. Both of these processes are inexpensive and easy. A special strain hardening is described in paragraphs to follow. The bullet proof material proposed by us can easily be used as armor for tanks, planes, helicopters, ships, and any protective walls, such as in bunkers. With a few minor changes it can also be used as a material for bullet resistant vests.

### DRAWING FIGURES

FIG. 1 shows methods of strengthening the material through hardening and carburization:
a) FIG. 1 A shows putting two sheets of steel together with a metal rod in between them.
b) FIG. 1B shows two pre-bent sheets of steel pressed onto each other.
c) FIG. 1C shows a schematic diagram of carburization.

FIG. 2 shows a 3-dimensional view of all sheets and rods prepared and ready to be compressed and combined.

FIG. 3 shows a cross sectional view of the final stage of assembling the bullet resistant material. Top and bottom foundations are about to be pressed against the central sheet. These three elements will then be connected with rivets.

### REFERENCE NUMERALS IN DRAWINGS

1. Flat, bottom sheet.

2. Bottom metal rods.

3. A sheet bent into a “V” pattern—fits onto the metal rods on the bottom.

4. A sheet bent into a trapezoidal pattern—roughly fits onto sheet 3.

5. A center sheet.

6. A sheet bent into a trapezoidal pattern—roughly fits onto sheet 7.

7. A sheet bent into a “V” pattern—fits onto the metal rods on the top.

8. Top metal rods.

9. Flat, top sheet.

10. Top foundation (composed of items 6, 7, 8, and 9)

11. Bottom foundation (composed of items 1, 2, 3, and 4)

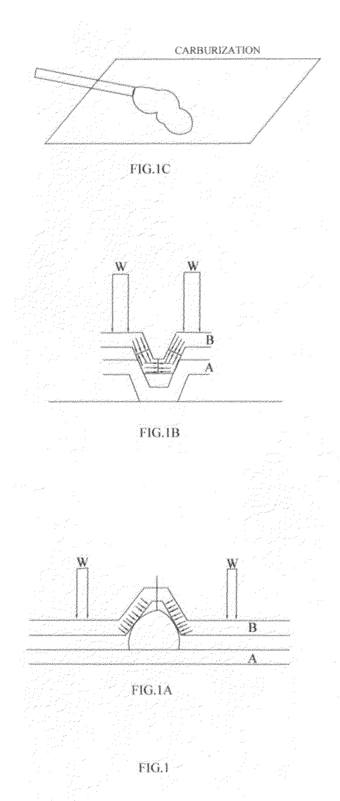

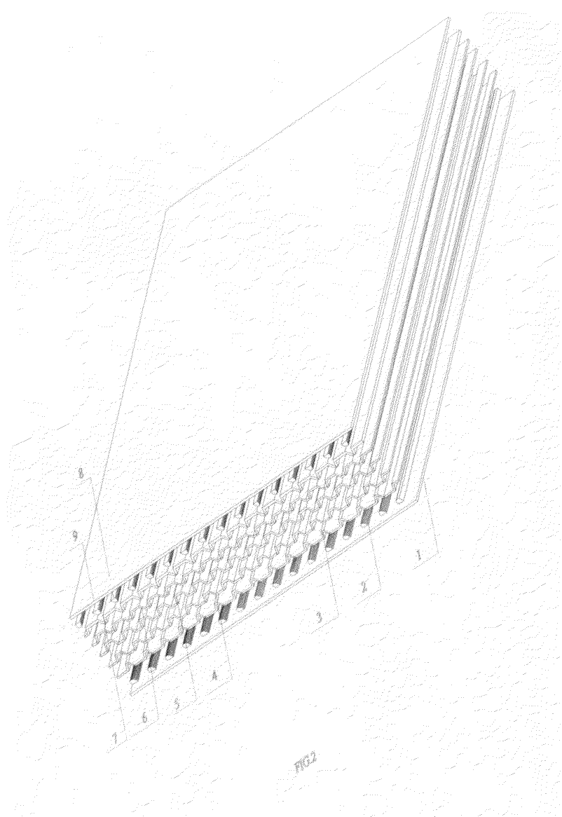

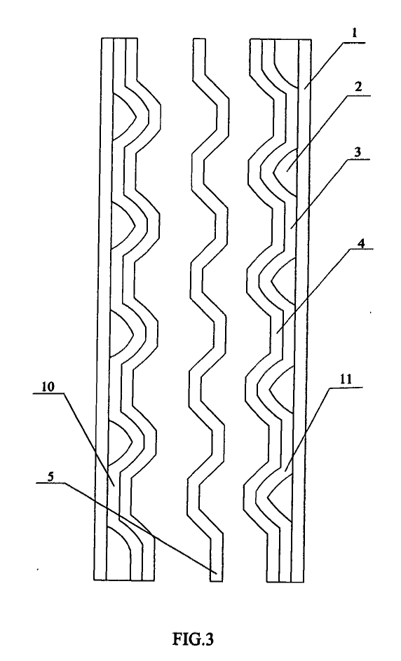

### DESCRIPTION—FIG. 2 AND FIG. 3

FIG. 2 shows a 3-dimensional view of all the sheets of steel (bent into appropriate patterns), and metal rods placed on the bottom and top panels, ready to be compressed. This compression will mold the components together. In FIG. 2 one can clearly see the metal rods, and the patterns into which individual sheets of steel are bent. Carburization should be performed after bending steel sheets into appropriate patterns.

FIG. 3 shows a cross sectional view of all the pieces compressed together: the bottom and top foundations, along with the central sheet in between. Note that the bottom and top foundations need to be prepared in advance. To prepare these foundations four elements need to be compressed together: the bottom (or top) sheet, the metal rods, and the “V” shaped sheet (item 3, or 7), and the trapezoidal sheet (item 4, or 6). Both the bottom and the top foundations are identical. Once these two are prepared, then the central sheet (item 5) is inserted in between the two foundations. All three elements are then riveted together. Another option is to glue them together. The actual thickness of the finished product depends on the diameter of rods used, as well as on the thickness of the carbon steel sheets used.

I claim:

1. Application of the strain hardening in the production of the bullet resistant materials.

2. The design/pattern of the carbon steel sheets (both “V” and trapezoidal patterns).

3. Application of carburization to the production/manufacturing of bullet resistant materials.

4. Metal rods as applied in the production/manufacturing of bullet resistant materials.

5. The production method:
a) preparation of individual sheets according to FIG. 1B.
b) carburization of individual sheets.
c) preparation/formation of bottom and top foundations.
d) final assembling of all the components
